(19) United States
(12) Patent Application Publication
(10) Pub. No.: US 2010/0114691 A1
(43) Pub. Date: May 6, 2010

(54) MANAGING A MARKETING TEMPLATE USED IN AN E-MAIL MARKETING CAMPAIGN

(75) Inventors: Alicia Yu Jen WU, San Mateo, CA (US); Tara U. ROBERTS, Austin, TX (US); David HAMM, Surrey (CA)

Correspondence Address: Squire, Sanders & Dempsey L.L.P.;Oracle International Corporation, 8000 Towers Crescent Drive, 14th Floor, Vienna, VA, 22182, US

(73) Assignee: ORACLE INTERNATIONAL CORPORATION, Redwood Shores, CA (US)

(21) Appl. No.: 12/483,358

(22) Filed: Jun. 12, 2009

Related U.S. Application Data
(60) Provisional application No. 61/111,450, filed on Nov. 5, 2008.

(51) Int. Cl. G06Q 30/00; G06Q 99/00; G06F 17/30; G06F 15/16

(52) U.S. Cl. 705/14.44; 705/14.45; 705/14.72; 709/206; 707/E17.014; 707/E17.044; 705/319; 705/10

(57) ABSTRACT

Embodiments of systems, methods, and software applications, which are configured to manage marketing templates that are to be used in e-mail marketing campaigns, are described in the present disclosure. According to one embodiment, among many, a computer readable medium is configured to store instructions that are executable by a processing device. The computer readable medium includes logic adapted to enable a user to create a marketing template and logic adapted to enable the user to publish the marketing template on one or more social networks. The computer readable medium also includes logic adapted to enable the user to incorporate the marketing template into an e-mail marketing campaign. Furthermore, the computer readable medium comprises logic that is adapted to track statistics related to recipients' responses to the e-mail marketing campaign.

### CROSS-REFERENCE TO RELATED APPLICATIONS

This application claims the benefit under 35 U.S.C. 119(e) of U.S. Provisional Application No. 61/111,450, filed Nov. 5, 2008.

### TECHNICAL FIELD

The present disclosure generally relates to marketing campaign activities of a sales agent of a company. More particularly, the embodiments described herein relate to systems and methods for creating, sharing, and tracking marketing templates that can used in e-mail marketing campaigns.

### BACKGROUND

Marketing campaigns, or sales campaigns, typically involve attempting to develop prospective customers or clients and nurturing the relationships with existing customers or clients. In many instances, marketing campaigns can be performed using e-mail communications, especially when a sales agent intends to communicate with multiple customers at once. Some e-mail marketing campaigns involve the preparation of a template that can be used for a particular group of customers. The template can be designed such that the e-mails can be personalized for each customer by inserting the customer's name in specific fields. The templates can include text, images, links to websites or documents, etc. Different types of software applications can be run on a regular desktop or laptop computer to enable the user to create a marketing campaign. Once prepared, the marketing campaign can be distributed to a number of customers or clients via e-mail.

In some cases, when a user within a company wishes to create a marketing campaign, the user might decide to access a file system associated with the company with which the user is employed. Thus, the user can then download any marketing campaigns that may have been prepared by peers and saved on the file system. Also, the user might search for relevant content on the Internet or other networks, etc. After gathering information from various sources, the user may realize that the content of the various marketing campaigns might not be useful for the user's particular purpose. Although some information on a company's network might be useful in a marketing campaign for a first group of customers, the same information might not be as useful in another marketing campaign for a second group of customers.

### SUMMARY

The present disclosure describes several embodiments of systems, methods, and processing logic for managing marketing templates, which can be used in e-mail marketing campaigns. Regarding one particular embodiment, a computer readable medium, which is configured to store instructions that are executable by a processing device, includes logic adapted to enable a user to create a marketing template. Also included in the computer readable medium is logic adapted to enable the user to publish the marketing template on one or more social networks. The computer readable medium also includes logic adapted to enable the user to incorporate the marketing template into an e-mail marketing campaign. Furthermore, the computer readable medium comprises logic that is adapted to track statistics related to recipients' responses to the e-mail marketing campaign.

Other features, advantages, and implementations of the present disclosure, not expressly disclosed herein, will be apparent to one of ordinary skill in the art upon examination of the following detailed description and accompanying drawings. It is intended that such implied implementations of the present disclosure be included herein.

### BRIEF DESCRIPTION OF THE DRAWINGS

The components of the following figures are illustrated to emphasize the general principles of the present disclosure. Reference characters designating corresponding components are repeated as necessary throughout the figures for the sake of consistency and clarity.

FIG. 1 is a diagram illustrating a marketing campaign management system according to one embodiment.

FIG. 2 is a block diagram illustrating one of the end-user devices shown in FIG. 1, according to one embodiment.

FIG. 3 is a block diagram illustrating the campaign management module shown in FIG. 2, according to one embodiment.

FIG. 4 is a block diagram illustrating the template library managing module shown in FIG. 3, according to one embodiment.

FIG. 5 is a block diagram illustrating the private community managing module shown in FIG. 4, according to one embodiment.

FIG. 6 is a block diagram illustrating the social metadata module shown in FIG. 4, according to one embodiment.

FIG. 7 is a diagram illustrating a user interface (UI) for enabling a user to search and view marketing templates, according to one embodiment.

FIG. 8 is a diagram illustrating a UI for enabling a user to view marketing templates and template properties, according to one embodiment.

FIGS. 9-11 are diagrams illustrating a UI for enabling a user to view marketing templates in different communities, according to a number of embodiments.

FIG. 12 is a diagram illustrating a UI for enabling a user to create and/or edit a marketing template, according to one embodiment.

FIG. 13 is a diagram illustrating a UI for enabling a user to store a copy of a marketing template, according to one embodiment.

FIG. 14 is a diagram illustrating a UI for enabling a user to create an e-mail marketing campaign, according to one embodiment.

FIG. 15 is a diagram illustrating a UI for enabling a user to test an e-mail marketing campaign, according to one embodiment.

FIGS. 16-17 are diagrams illustrating a UI for enabling a user to view information monitored with respect to an e-mail marketing campaign, according to a number of embodiments.

FIG. 18 is a diagram illustrating a UI for enabling a user to view the status of an e-mail marketing campaign, according to one embodiment.

FIGS. 19-20 are diagrams illustrating UIs for enabling a user to view e-mail marketing campaigns being tracked, according to a number of embodiments.

FIG. 21 is a flow diagram illustrating a method of managing an e-mail marketing campaign, according to one embodiment.

### DETAILED DESCRIPTION

When creating a marketing campaign using computer software, a user, such as a sales agent, may need to access information from various sources. Not only can researching and gathering relevant information for the marketing campaign be time consuming, but sifting through a great amount of information to determine what information is relevant can be time consuming as well. After this, the user may spend a large amount of time actually creating a marketing campaign, especially if the user does not have much experience with respect to computer software for creating pages of text and graphics.

In order to improve the processes for creating a marketing campaign compared to conventional preparation techniques, the embodiments of the present disclosure comprise the establishment of a centralized system that allows sharing of marketing templates within an enterprise, company, organization, or other group. Marketing templates refer to pages of text and graphics used for advertising purposes. Also, the templates may include a hypertext markup language (html) format to allow certain fields to be filled in automatically, such as for personalizing a letter to customers with the customer's name. As described in the present disclosure, the embodiments herein streamline the process of creating new marketing templates by tapping into the collective experience of the organization. When a successful marketing template is created, that success can then be shared, replicated, and enhanced by everyone in the organization. Thus, the benefits of utilizing the systems described herein for managing marketing campaigns that utilize the marketing templates can then be multiplied throughout the organization.

Even though a vast repository of content can be made available to the users, it may still be difficult for a user to determine the significance or usefulness of certain content within a number of marketing templates. However, with a centralized template sharing system, a user can access the marketing templates within one or more communities that may be associated with the company within which the user works. In some instances, the communities are referred to herein as enterprise social networks (ESNs) or simply social networks. Thus, the user can find marketing templates that other members within the ESNs have shared. Also, the user can access tags, comments, and ratings that others have provided for the respective marketing templates. The user can easily review the previously submitted tags, comments, and rating, which can help the user determine the relevance of the content for the user's purposes and help hone in on the most effective material. Therefore, the user has quick access to recently prepared marketing templates to stay up-to-date on the latest marketing campaigns that have been shared by peers.

In some embodiments, a sales agent may use an end-user device to access a marketing template from a remote database associated with a centralized server. While viewing the available marketing templates, the user can download a relevant template and store a copy on the user's computer. At this point, the user can edit or enhance the downloaded content according the user's needs using conventional software processing means.

In addition, when the user has prepared a new marketing template from scratch or edited a downloaded copy of an existing template, the user can then upload the newly created marketing template onto the server's database, allowing the new marketing template to be available to others. Regarding the upload process, a company or enterprise may consist of a number of ESNs, which may include groups of members within the enterprise having specific interests or goals. Thus, the new marketing template may be shared in one or more ESNs, depending on the relevance of the content of the marketing template to each respective ESN. To share the content, a user can upload the marketing campaign onto the relevant ESNs, which may be similar to a publish operation within some types of social networks.

According to the embodiments herein, other members of an ESN can therefore easily leverage the marketing templates that have been published and stored with respect to the particular ESN, browse through the templates, view the tags, comments, and rating associated with the respective templates to help determine if a particular template might be appropriate for the user's purposes, and download a copy of a selected marketing template. This user can also upload a new marketing template and thereby continue the process for managing the shared marketing templates.

From the collection of shared marketing templates, a user can then create an e-mail marketing campaign. By setting up a contact list for a group of customers or clients, the user can incorporate a selected marketing template into an e-mail. In other embodiments, the marketing template can be associated with the e-mail in an attachment, link, or by using some other type of relationship. The template may be designed to automatically include the customer's name or some other personalization information in some fields of the template. Then, the e-mail is transmitted to the customers in the particular contact list or distribution list to initiate the e-mail campaign.

Furthermore, according to the embodiments herein, the e-mails sent in an e-mail campaign are processed through a central system, which is configured to automatically track how the recipients of the e-mail respond to the e-mail campaign. For example, statistics can be gathered to determine how many recipients opened the e-mail, how many recipients clicked through the e-mail, the number of times a particular marketing template has been used in e-mail campaigns, the last time the marketing template was used in an e-mail campaign, etc. Therefore, the statistics can help to determine the marketing templates and e-mail campaigns that are successful, so that other sales agents within a company may re-use them or gain insight into the types of templates and campaigns that are successful.

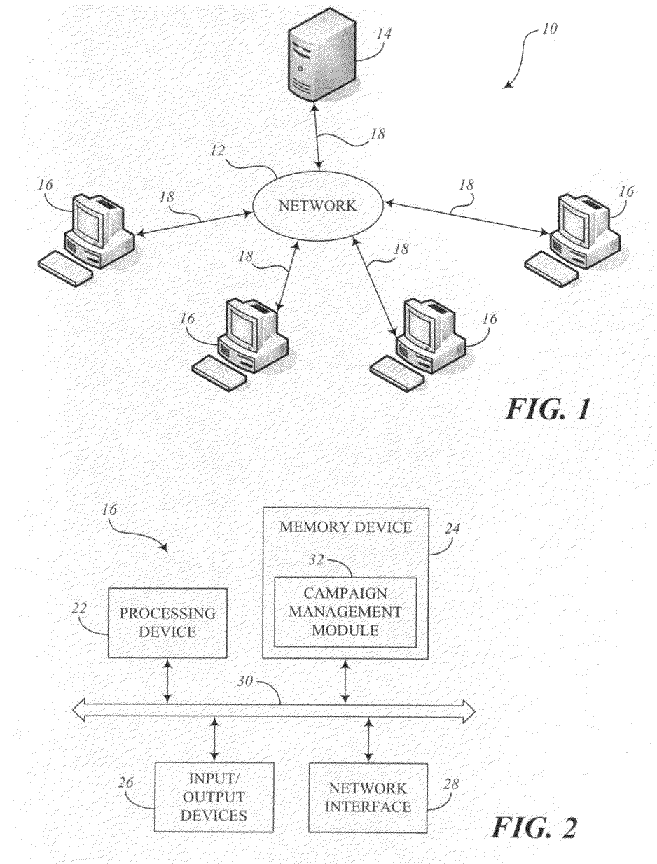

FIG. 1 is a diagram illustrating an embodiment of a marketing campaign management system 10 according to one implementation. In this embodiment, marketing campaign management system 10 includes a network 12 for enabling communication among a server 14 and end-user devices 16 via communication channels 18. Network 12 and communication channels 18 may include any suitable combination of switches, relays, transmission lines, wireless communication channels, etc., for allowing data and information to be exchanged. In particular, data can be uploaded from an end-user device 16 to server 14 and downloaded from server 14 to an end-user device 16.

Server 14 may include internal memory or be in communication with external memory for storing marketing templates, which have been prepared and uploaded by a number of users. These marketing templates can then be shared with user via end-user devices 16. The memory associated with server 14 may also store other information related to the marketing templates. For example, the extra information may include text extracted from the marketing templates. Also, the extra information may include image information extracted from a snapshot of the marketing templates.

Server 14 is also configured to provide search functionality to allow users to conduct text searches, or key word searches. The searches can be matched with text in the marketing templates themselves or with tags that are entered for describing the marketing templates. Server 14 can also store and manage comments, reviews, tags, key words, ratings, etc., that are associated with the respective marketing templates. In some cases, users can add tags, comments, and/or ratings, which are stored in server 14. Furthermore, server 14 can download an individual marketing template upon request and enable the user to upload a newly created marketing template from the end-user devices 16. When these new marketing templates are uploaded, server 14 can perform a text extraction process and a graphic image extraction process to form text files and images files associated with the respective marketing templates.

It should be recognized that some or all of the functionality of server 14 as described in the present disclosure can be performed by one or more end-user devices 16. Likewise, some or all of the functionality of end-user device 16 as describe herein can be performed by server 14. Furthermore, some functionality can be performed on both server 14 and end-user device 16, according to the particular design.

FIG. 2 is a block diagram illustrating an embodiment of one of the end-user devices 16 (or server 14 or both) shown in FIG. 1, according to one implementation. In this embodiment, end-user device 16 includes a processing device 22, memory device 24, input/output devices 26, and network interface 28, each interconnected via a bus 30. Network interface 28 enables communication between end-user device 16 and server 14 via network 12. Memory device 24 contains, among other things, campaign management module 32.

End-user device 16 may be a computing system, such as a computer, data processing system, or other suitable electronic device for executing logic instructions, e.g., software applications. Processing device 22 may be a general-purpose or specific-purpose processor or microcontroller. Memory device 24 may include one or more internally fixed storage units, removable storage units, and/or remotely accessible storage units. Also, memory device 24 may include any suitable combination of volatile memory and/or non-volatile memory and can be configured to store information, data, instructions, and/or software code. Input/output devices 26 may include input mechanisms such as keyboards, keypads, cursor control devices, or other data entry devices. The input mechanisms enable a user to enter information or instructions in end-user device 16. Input/output devices 26 may also include output mechanisms, such as computer monitors, display screens, audio output devices, printers, or other peripheral devices for communicating information to the user.

The embodiments of campaign management module 32 described in the present disclosure can be implemented in hardware, software, firmware, or a combination thereof. When implemented in software or firmware, campaign management module 32 can be stored in memory device 24 (as shown) and executed by processing device 22. Alternatively, when implemented in hardware, campaign management module 32 can be implemented in processing device 22 using discrete logic circuitry, an application specific integrated circuit (ASIC), a programmable gate array (PGA), a field programmable gate array (FPGA), or any combination thereof.

Campaign management module 32 can include functionality to allow a user to access previously prepared marketing templates from server 14, such as by conducting a text search to search for marketing templates stored with respect to server 14. Campaign management module 32 also enables a user to download a shared marketing template to store a copy in memory device 24. Campaign management module 32 may also be configured to allow the user to create a new marketing template from scratch and/or edit a copy of a downloaded marketing template. The user is also enabled to upload a completed marketing template to server 14 in order that the new template can be shared with peers.

Campaign management module 32 and other software, computer programs, or logic code that includes executable logical instructions as described herein, can be embodied in a computer-readable medium for execution by any suitable processing device. The computer-readable medium as described herein can include one or more suitable physical media components that can store the software, programs, or code for a measurable length of time.

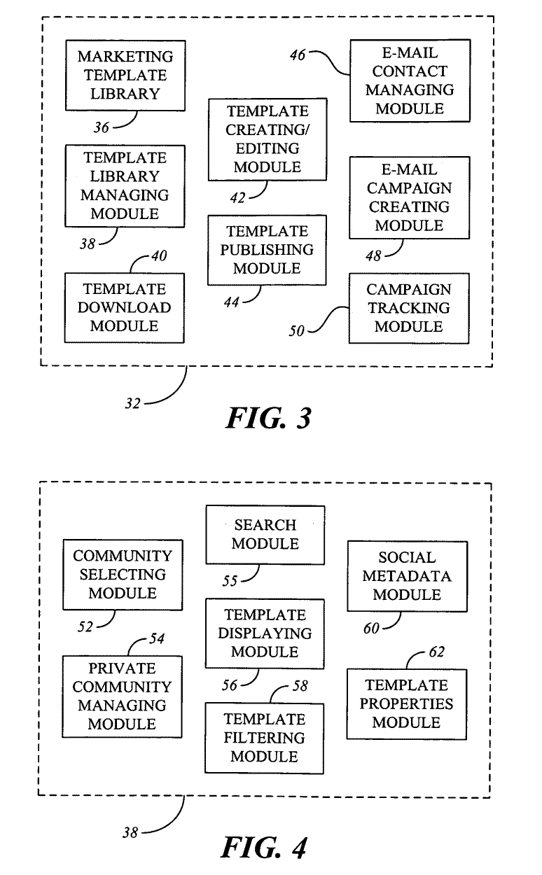

FIG. 3 is a block diagram illustrating an embodiment of campaign management module 32 shown in FIG. 2, according to one implementation. In this embodiment, campaign management module 32 includes a marketing template library 36, a template library managing module 38, a template download module 40, a template creating/editing module 42, a template publishing module 44, an e-mail contact managing module 46, an e-mail campaign creating module 48, and a campaign tracking module 50. In other embodiments, campaign management module 32 may include more or fewer modules. Also, some modules mentioned herein may be combined together and/or some modules may be divided into multiple modules.

Marketing template library 36 is configured to aggregate and store one or more marketing templates. In some embodiments, marketing template library 36 may be associated with server 14 for storing a plurality of templates for each community or ESN. Also, information regarding the respective communities in which each marketing template is stored can be handled by marketing template library 36 as well. With respect to local memory associated with an end-user device 16, marketing template library 36 may be configured to store only those templates that the user has saved internally and that are still in progress or to store templates that have been downloaded from server 14.

Marketing template library 36 may include one or more internally fixed storage units, removable storage units, and/or remotely accessible storage units. Also, marketing template library 36 may include any suitable combination of volatile memory and/or non-volatile memory and can be configured to store information, data, instructions, and/or software code.

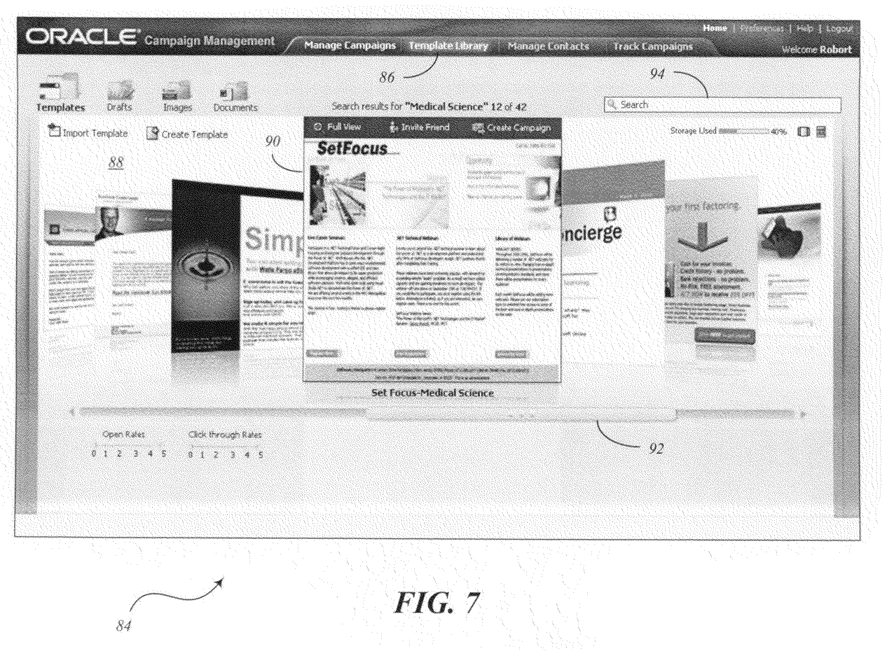

Template library managing module 38 may be configured with user interfaces, for example, as mentioned in more detail with respect to FIGS. 7-20. Also, one embodiment of a template library managing module 38 is described below with respect to FIG. 4. In particular, template library managing module 38 allows a user to browse through a number of accessible marketing templates. In particular, the browsing may include selecting a community or communities with which the user is a member. For example, when it the desire of the user to access marketing templates related to a certain interest, which may be represented by a community, the user can browse the templates in that community to see the templates previously prepared by other members of the community. Template library managing module 38 also allows the user to create a private community if desired. In this way, a group of marketing templates can be managed with a private community for a particular purpose.

Template library managing module 38 is also configured to enable a user to conduct a text search using search terms that may match with the text within one or more marketing templates. Template library managing module 38 also displays the templates in an organized manner for the user's viewing and allows the user to filter the results if desired. In addition, social metadata is displayed with respect to each marketing template, as explained in more detail below. In addition to social metadata, template library managing module 38 can also display other properties of the respective templates. Template library managing module 38 can aggregate the templates and information associated with the templates and store the templates and information in marketing template library.

In the embodiment of FIG. 3, campaign management module 32 further includes template download module 40. When the user has browsed through the available marketing templates and decided to copy one for his or her own use, the user can utilize template download module 40 for performing a download process from server 14 to end-user device 16. Therefore, both server 14 and end-user device 16 may include compatible processing means for enable the download from one device to another.

Template creating/editing module 42 enables a user to create a marketing template from scratch using any suitable word processing and/or graphical processing means available to the user. Also, the user can edit the marketing template created from scratch and/or edit one or more templates that have been downloaded and saved locally. In some embodiments, template creating/editing module 42 may be omitted from campaign management module 32, but may instead be part of an external software program that enables the creating and/or editing of such templates.

Template publishing module 44, like template download module 40, may include portions in both server 14 and end-user device 16 to enable a template to be uploaded to server 14. Template publishing module 44 enables the user to upload a new template or an edited template to server 14 such that the uploaded template is available on one or more communities. This is similar to a publish operation within a social network.

In some embodiments, template publishing module 44 may be associated with logic configured to perform a text extraction process to extract all the text from the uploaded marketing template. This functionality, for example, may be included in logic associated with server 14, which receives the uploaded template. The text can then be stored in a separate file from an image file captured for the template. When a text search is done, the text file for each marketing template can be compared with the search terms to determine the success of the search.

Template publishing module 44 may also be configured to perform several functions to organize marketing template library 36 such that individual marketing templates can be searched. Much of this functionality can be considered to be performed in the background without the user's knowledge. The organizational processes of forming text files and image files from the marketing templates can be done during a set-up stage when marketing campaign management system 10 is initially established. In the set-up stage, template publishing module 44 can receive multiple marketing templates uploaded into marketing template library 36 and process and store additional text and image files in marketing template library 36. Also, template publishing module 44 can be used in an ongoing manner when new marketing templates are uploaded and stored into marketing template library 36.

As time goes on, the amount of content in marketing template library 36 can grow to include a vast database of marketing template content available to the users. When numerous members of the organization or enterprise share their marketing templates, the creation of new marketing templates can be done more efficiently and can often provide a wider breadth of material since it is gathered from many different sources.

Template publishing module 44 allows a new marketing template created by a user to be uploaded into marketing template library 36. Template publishing module 44 also enables the user to pick which ones of a number of ESNs in which the marketing template is to be shared. Thus, users can publish the marketing template on one or more communities or ESNs. Once published, other members of a respective community can search that content, add comments, tags, or ratings for that content, and leverage the content for downloading to use or to edit as needed. It should be noted that in many embodiments, a marketing template cannot be changed by another user. However, the user may download and save a copy of the marketing template, edit that template, and then upload the template as a new template.

When a new template is created, the user can press an upload button or other suitable upload selection mechanism associated with template publishing module 44, which is configured to upload the new template to marketing template library 36. The upload process can be compared to a publish process used in social networks to post or submit new material to a server. Template publishing module 44 may be configured to open a window on a user interface that allows the user to select one or more ESNs that can receive the uploaded template. In some embodiments, the available ESNs shown to the user can be those of which the user is actually a member.

Still referring to FIG. 3, e-mail contact managing module 46 enables a user to manage a collection of e-mail contacts, which the user can send e-mails to. In some embodiments, e-mail contact managing module 46 may be incorporated in a separate e-mail application or can include communication with a user's e-mail application running independently of campaign management module 32. E-mail contact managing module 46 can be used at any time during the marketing campaign process to update e-mail addresses, add new contacts, create distribution lists, etc.

E-mail campaign creating module 48 is configured to enable the user to create a new e-mail marketing campaign. An e-mail marketing campaign refers to a mass distribution of e-mails to one or more contacts, which may be grouped in a distribution list, where the e-mail includes a selected marketing template attached to the e-mail. The template may include html code for filling in particular data with the text. For example, the template may add a customer's first name or last name, or a city in which the customer resides, etc.

Campaign tracking module 50 is configured to automatically track the statistics of certain aspects of the e-mail campaign. For example, campaign tracking module 50 can keep a record of the percentages of recipients who have opened the e-mail, percentages of recipients who have clicked on a link within the marketing template, etc. These statistics can be gathered and stored in association with each particular template and/or in association with each e-mail campaign. Then, when the marketing templates are browsed at a later time by other users, those statistics can be shown in order to indicated how effective the e-mail campaign or marketing template is. Campaign tracking module 50 aggregates responses and social metadata of templates across multiple campaigns. The aggregated information can be shown on a UI that displays the responses and social metadata in any suitable form, such as in a pie chart, and can be used with filter. In some embodiments, the templates are individually tracked rather than the individual marketing campaigns.

FIG. 4 is a block diagram illustrating an embodiment of template library managing module 38 shown in FIG. 3, according to one implementation. In this embodiment, template library managing module 38 includes a community selecting module 52, a private community managing module 54, a search module 55, a template displaying module 56, a template filtering module 58, a social metadata module 60, and a template properties module 62.

Community selecting module 52 is configured to enable the user to select one or more communities from a list of communities with which the user is a member. The selectable communities may be public communities that are accessible by any members thereof or private communities that can only be accessed by people who are invited to join. In any case, the user can access and browse the available marketing templates in the selected one or more communities.

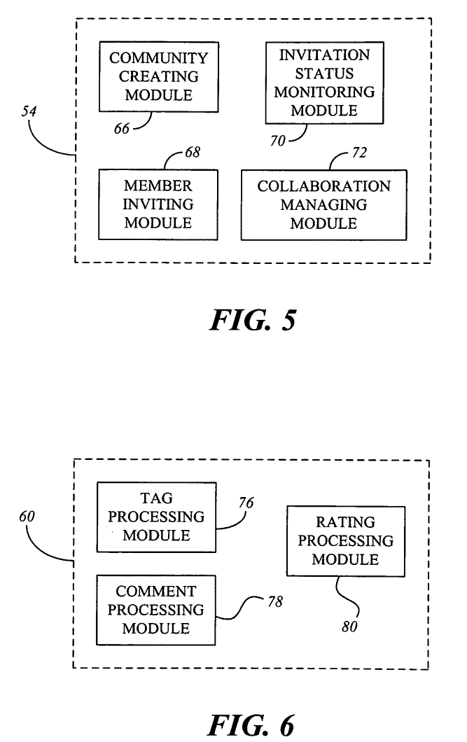

Private community managing module 54, which is described in more detail below with respect to FIG. 5, is configured to enable a user to create a new private community. When a private community is set up, the user can then invite certain people to join and then monitor the status of the invitations. Also, with a private community, the user can establish and edit collaboration rules for how member of the private community can handle marketing templates and e-mail campaigns based on these marketing templates.

Search module 55 is configured to manage the search functionality of template library managing module 38. Search module 55 can receive search term, for example, from a user on end-user device 16. When multiple search terms are entered, search module 55 can accept exact phrases, AND operators, OR operators, or any combination of these. Search module 55 matches the search terms with the text files that are extracted from the marketing templates and stored in marketing template library 36. The search terms can be matched with text appearing anywhere in the marketing templates. In some embodiments, search module 55 can perform a search within a particular social network or ESN with which the searching user is associated. Therefore, only the search results for the templates relevant to the particular searcher are revealed. Also, in some cases, search module 55 can ignore certain stop words, such as “a,” “the,” etc.

In some embodiments, search module 55 can arrange the search results in an order based on the number of times the search term appears in a particular marketing template. Another criteria for ordering search results may include the age of the template, where the most recent templates are ordered first. Search module 55 can then send information associated with the templates, e.g., text information files and graphic files, to end-user device 16 for displaying the search results using a UI, as explained in more detail below. Search module 55 can also use the tags associated with the marketing templates to match the search terms.

Template displaying module 56 include UIs for displaying templates that are being browsed. The templates in the display may include those revealed during the search process, those that are associated with a particular ESN, or both. In some embodiments, the templates may be arranged in a carousel arrangement, where a prominently displayed template is shown front and center and other templates are shown on a smaller scale off to the sides of the prominently displayed template. The templates on the side may also be displayed behind the prominently displayed template.

Template filtering module 58 enables a user to narrow down the number of templates that are being displayed. This may include narrowing the search results or eliminating templates within a selected community that do not meet certain criteria. The filtering process can be done when the number of hits is too large for the user's interest. Template filtering module 58 can filter out those templates that do not meet certain filter criteria. For example, the results can be filtered with respect to a minimum rating of the template, an oldest age of the template, and/or other filtering criteria.

Social metadata module 60, as described in more detail below with respect to FIG. 6, allows a user to view and/or add social metadata for a particular template, such as one that is prominently displayed in the carousel arrangement. The term “social metadata,” as used in the present disclosure, refers to tags, comments, reviews, ratings, etc. that apply to a particular marketing template. Members of a specific social network in which the marketing template is related can enter this social metadata, which can then be displayed for the other members who access that template at a later time. Not only can a member view the social metadata, but also the member can add further social metadata if the member desires. In this way, when several samples of social metadata are entered for a particular template, someone creating a new template can have a wealth of information about the template from a diverse group. This social metadata may be able to help the user decide whether or not to use the template in a new e-mail marketing campaign.

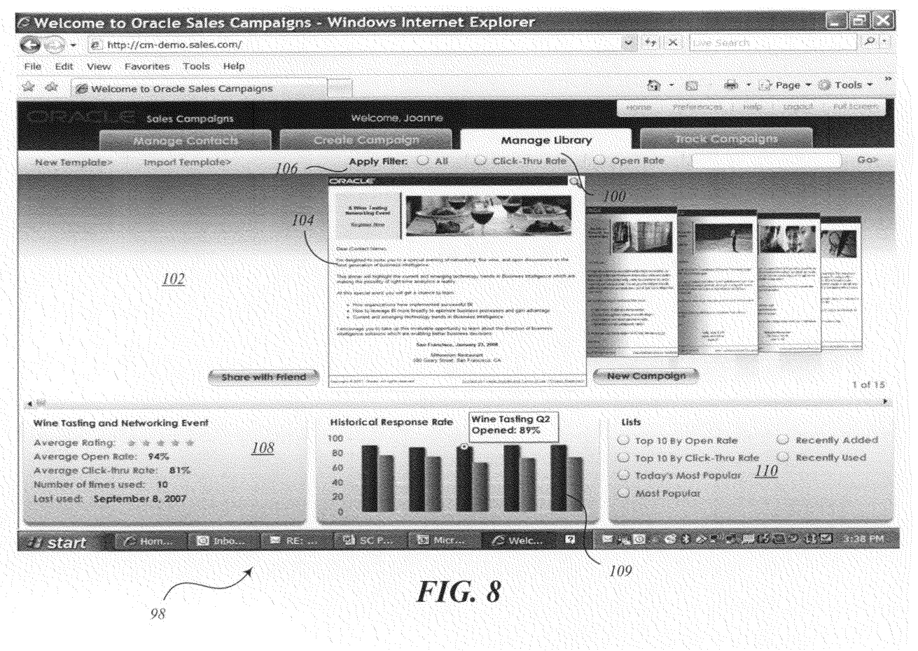

Template properties module 62 is configured to display on a UI certain properties of a highlighted marketing template. For example, template properties module 62 may display information that describes further details of the template that may be gathered by campaign tracking module 50 (FIG. 3). Some examples of template properties are shown at the bottom portion of the UI of FIG. 8 as explained below.

FIG. 5 is a block diagram illustrating an embodiment of private community managing module 54 shown in FIG. 4, according to one implementation. In this embodiment, private community managing module 54 includes a community creating module 66, a member inviting module 68, an invitation status monitoring module 70, and a collaboration managing module 72. Community creating module 66 enables a user to create a private community, which can include any members that the user chooses. The private community may be set up for a particular purpose and may include people outside the context of an ESN that is associated with a single enterprise. For example, collaboration on a particular project may include help from an employee of a different company working in cooperation with the user's company.

Member inviting module 68 enables the user to send invitations to selected individuals to ask them to join the private community. This may be similar to invitations used in association with other types of social networks. Invitation status monitoring module 70 can then monitor the status of the invitations sent to these individuals to see whether they accept, reject, not yet view, view but not yet respond, etc. Collaboration managing module 72 enable the user to set up a number of rules for collaborating on a marketing template and/or e-mail campaign. The collaboration rules may also apply to viewing privileges for certain statistics of the templates and campaigns.

FIG. 6 is a block diagram illustrating an embodiment of social metadata module 60 shown in FIG. 4, according to one implementation. In this embodiment, social metadata module 60 includes a tag processing module 76, a comment processing module 78, and a rating processing module 80. Tag processing module 76, comment processing module 78, and rating processing module 80 represent the user interface components for viewing and/or adding social metadata. The social metadata may be stored contextually with respect to the particular ESN or ESNs in which the social metadata was entered. In this way, a might be more useful with respect to one community while not so useful in another community.

Tag processing module 76 is configured to store tags, or key words, which are used to define a template. For example, if a template does not necessarily include specific searchable text within the template itself, a tag can be applied for the purpose of identification. When a template if first uploaded, tag processing module 76 allows the person who uploaded the template to enter key words that can help to group specific templates within the same category. Thus, tags can help to form these associations or categories among the templates and can help to filter the content based on how others may have used particular key words. Particularly, other users who access the template at a later time can also add tags if desired. Tag processing module 76 sends tag information to the UI associated with end-user device 16 to display the tags that have already been entered for the respective templates.

If a key word is being used multiple times to associate a certain template with the particular key word, tag processing module 76 can render that key word on the UI with a larger font size or by some other highlighting technique to indicate that the popularity of that key word is higher than other key words. The monitoring of the frequency of this association is referred to herein as a “tag cloud.” This allows a user to quickly and easily find certain templates during a search process. In some embodiments, the tag words can be searched in the search process.

In some embodiments, tag processing module 76 may be configured to display four tags at a time. If more tags are associated with the particular template, a “more” button can be displayed to enable the user to view the additional tags. In some embodiments, tag processing module 76 can display the tags in alphabetical order. In other embodiments, the tags can be displayed by popularity or frequency of actual access by the particular tags. When a user wishes to add a tag, tag processing module 76 opens a text entry box to enable entry of a tag. After entry, tag processing module 76 may temporarily display a window with a message such as “Thank you for tagging!”

Comment processing module 78 is similar in some ways to tag processing module 76. Comment processing module 78 enables the display of comments or reviews that other users have made with respect to a particular template. These comments can be displayed on the UI during the search process. Also, comment processing module 78 enables the user to add a new review if desired. These comments can be used to help the searcher determine the relevance of the particular templates that are revealed during the search.

Comment processing module 78 may be configured to display comments within a limited amount of space. If the comments exceed this space, a “more” button can be displayed to enable the user to view the additional comments. When a user wishes to add a comment, such as by pressing a “post comment” button, comment processing module 78 opens a text entry box to enable entry of a comment. The text entry box may also include an indicator letting the user know how many additional characters can be entered without exceeding a limit. For example, the message may read “You have ## characters remaining.” In some cases, the limit may be 1000 characters. After entry of the comment, comment processing module 78 may display a message, such as “Thank you for your comment!” In some embodiments, comment processing module 78 may display the date and time that each respective comment was submitted and/or the name of the user submitting the comment.

Rating processing module 80, like tag processing module 46 and comment processing module 78, helps to provide additional information about the particular templates. However, rating processing module 80 is configured to show a rating scale of how effective or useful a particular template is perceived by a number of users. For example, the rating scale may include a number of “stars,” ranging from one star to five stars, for rating the template, such that one star represents “poor,” two stars represents “nothing special,” three stars represents “worth a look,” four stars represents “good,” and five stars represents “awesome.” Users can enter a rating based on the user's experience with the template or by some other observations. Rating processing module 80 is configured to average these ratings and then send the rating, e.g., number of stars, to the UI associated with end-user device 16 for display of the average rating. After the user enters a rating, rating processing module 80 can display a message, such as “Thank you for rating!”

FIG. 7 is a diagram illustrating an example of a user interface (UI) 84 for enabling a user to search and view marketing templates. In this embodiment, UI 84 includes, among other things, a template library tab 86 for allowing access to the template library, which may be associated, for example, with marketing template library 36 (FIG. 3). UI 84 also include a display area 88 showing a prominently displayed template 90 in a carousel arrangement in display area 88. UI 84 may utilize copies of high resolution images capture with respect to the multiple marketing template for display in the carousel arrangement. To navigate among a number of templates, the user can use a navigator slide 92. To conduct a search, the user can enter search terms in a search window 94.

FIG. 8 is a diagram illustrating an example of a UI 98 for enabling a user to view marketing templates and template properties. In this embodiment, UI 98 includes, among other things, a manage library tab 100, which may be associated, for example, with template library managing module 38 (FIG. 3). UI 98 also includes a display area 102 with a prominently displayed template 104 slightly superimposed over other secondary templates. UI 98 also includes a filter mechanism 106, which may be associated with template filtering module 58 (FIG. 4) of template library managing module 38. The templates can be filtered, for example, by “all,” “click-thru rate,” “open rate,” or other suitable filter criteria.

UI 98 also includes a first template properties window 108, a second template properties window 109, and a third template properties window 110. In first template properties window 108, statistics regarding average rating, average open rate, average click-thru rate, number of times used, and last used are displayed for the particular template, which in this case is prominently displayed template 104. Second template properties window 109 includes historical response rate for prominently displayed template 104 used in other e-mail marketing campaigns. Third template properties window 110 includes links to lists of other templates, such as the top 10 templates listed by open rate or click-thru rate, today's most popular templates, the most popular templates, recently added templates, recently used templates, and other suitable lists that can be accumulated by a campaign tracking module 50 and/or template properties module 62.

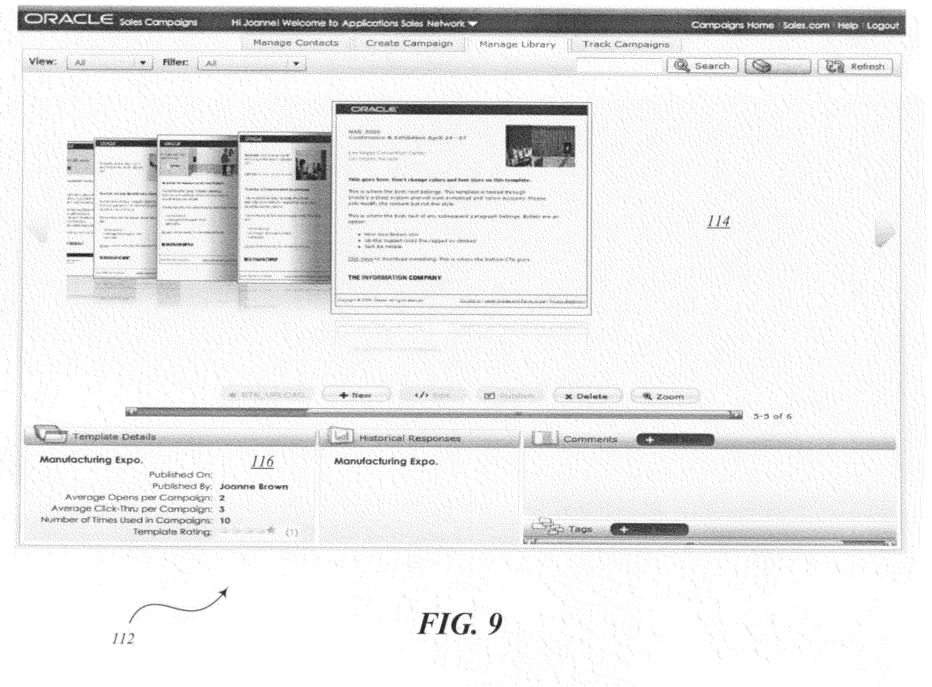

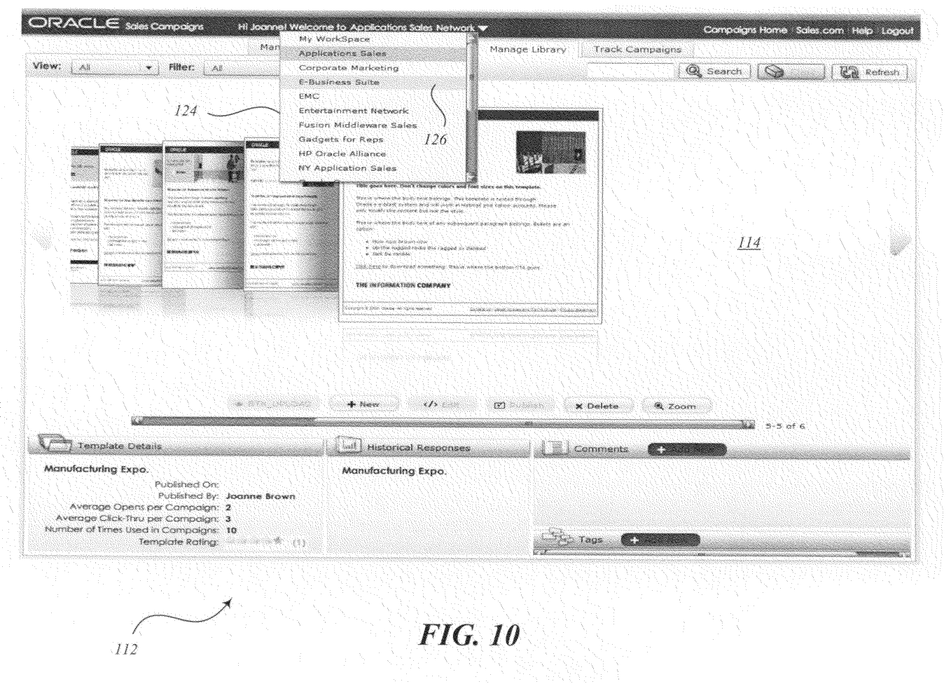

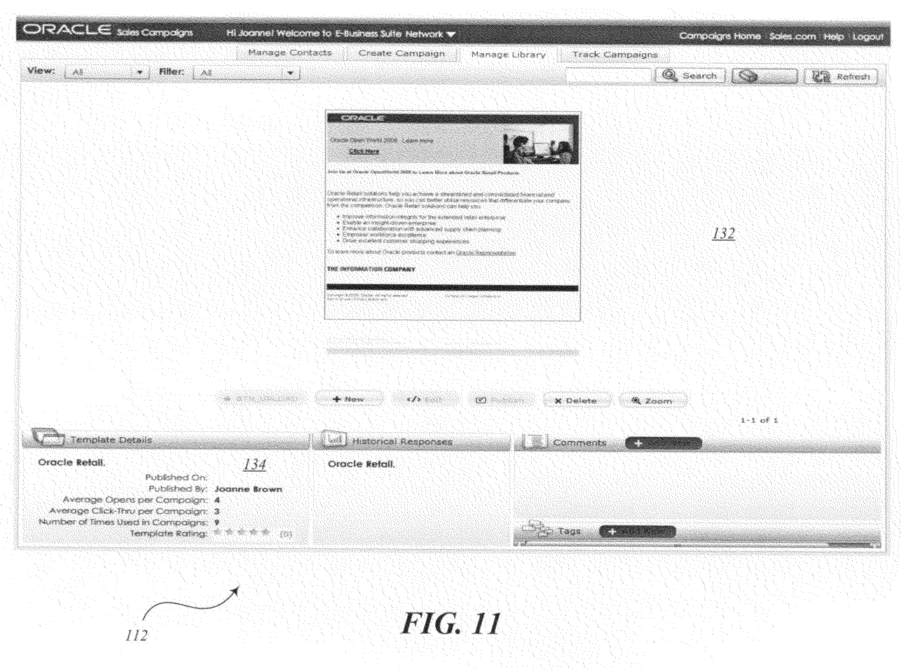

FIGS. 9-11 are diagrams showing examples of a UI 112 for enabling a user to view marketing templates in different communities. In FIG. 9, first UI 112 includes a display area 114 and template properties window 116 corresponding to the prominent template. In this example, a user is able to browse the templates in a first community, i.e., Applications Sales Network in this case. According to the template used within this community, certain statistics are kept with respect to this template in template properties window 116. The user may choose to select another community using UI 112 as shown in FIG. 10. In this case, the user can access a drop-down menu 124 to reveal other communities. When the user selects E-Business Suite 126, for example, within drop-down menu 124, UI 112 displays, as shown in FIG. 11, the results of this other community, i.e. E-Business Suite. UI 112 of FIG. 11 shows a new display area 132 showing new browse results for the community and with the statistics shown in template properties window 134 showing the relevant information for the prominent template of display area 132.

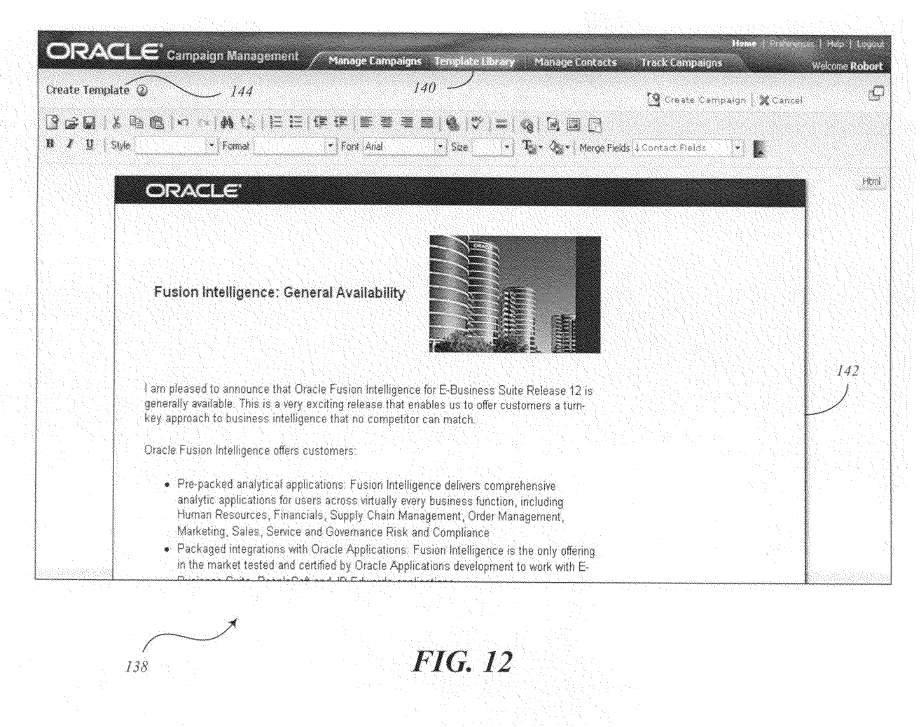

FIG. 12 is a diagram illustrating an example of a UI 138 for enabling a user to create and/or edit a marketing template. In this embodiment, UI 138 includes, among other things, a template library tab 140 for enabling access to previously prepared templates. In this case, a particular template 142 is downloaded and copied onto the user's local memory. If the user wishes to create a template from scratch, the user can click on “create template” link 144. As shown in this example, the user can edit template 142 as needed.

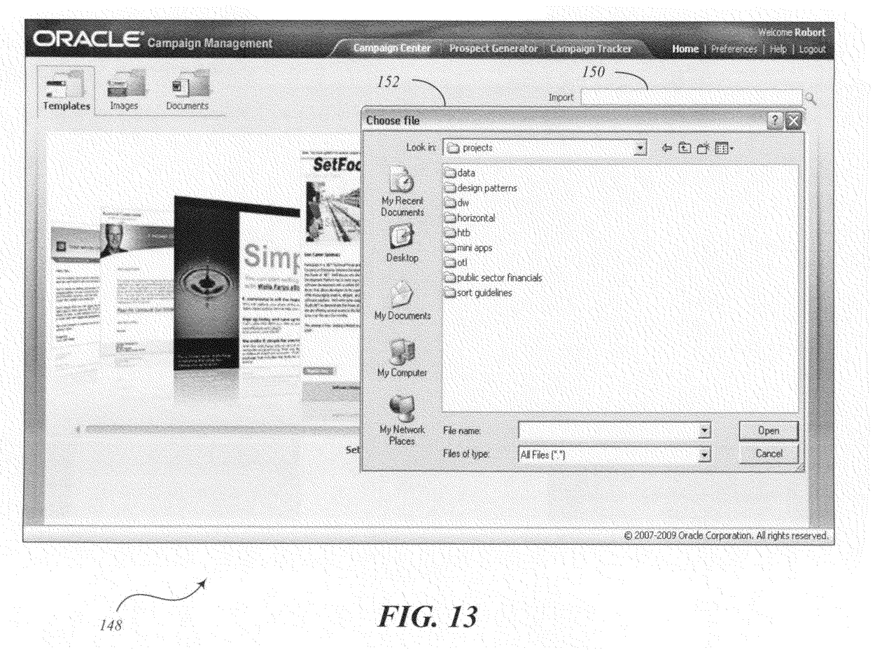

FIG. 13 is a diagram illustrating an example of a UI 148 for enabling a user to store a copy of a marketing template. When the user wishes to store a copy of a template, UI 148 enables the user to enter one or more communities into import field 150. A file can be downloaded or uploaded into a particular community using window 152.

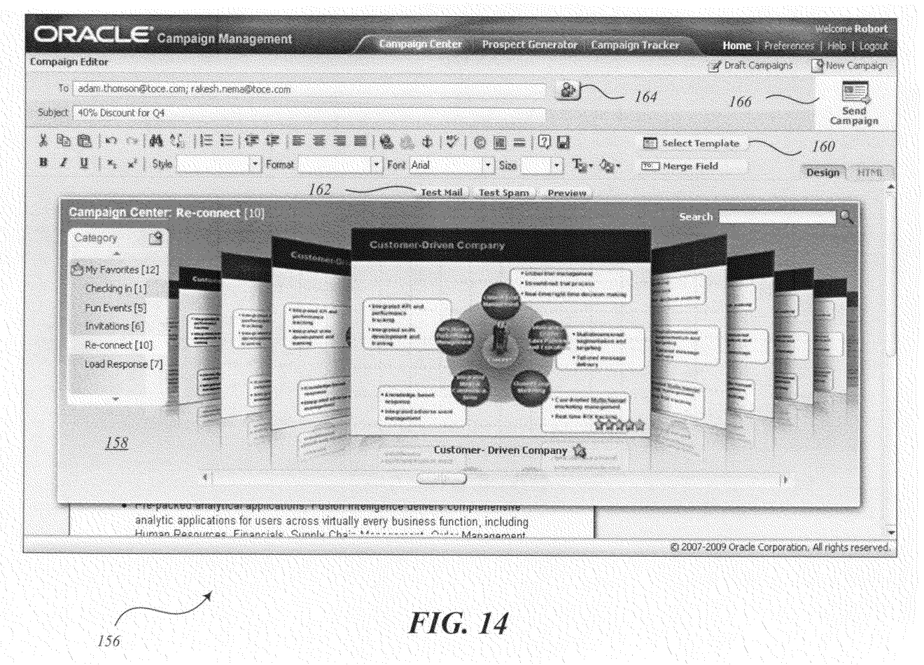

FIG. 14 is a diagram illustrating an example of a UI 156 for enabling a user to create an e-mail marketing campaign. For example, UI 156 may be used in conjunction with campaign tracking module 50 (FIG. 3). In this embodiment, UI 156 includes, among other things, a display area 158 for displaying a number of templates being browsed. UI 156 also include a select template button 160 for selecting a particular template for use in an e-mail marketing campaign. Before an e-mail campaign is distributed to a number of customers or clients, it may be beneficial to test the e-mail. In this respect, UI 156 includes test mail button 162 that allows the user to send a test e-mail to one or more recipients who may be able to provide feedback on the e-mail campaign before distribution. Then, if necessary, the user can make changes to the marketing template or e-mail marketing campaign. UI 156 also include a contact adding button 164 for adding or editing e-mail contacts. These may include customer and/or client e-mail addresses, e-mail addresses of colleagues, etc. Contac adding button 164 may be associated, for example, with e-mail contact managing module 46 (FIG. 3). When the e-mail campaign is ready for distribution, the user can then press the send campaign button 166, which initiates the distribution of the campaign to the listed recipients.

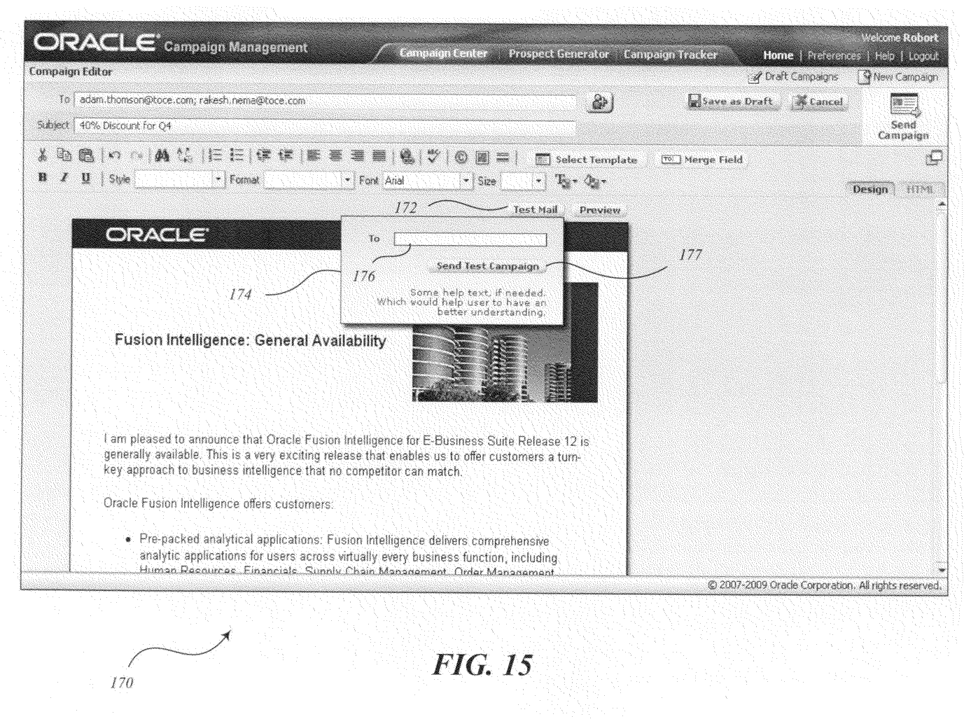

FIG. 15 is a diagram illustrating an example of a UI 170 for enabling a user to test an e-mail marketing campaign. In this embodiment, UI 170 includes, among other things, a test e-mail button 172 for testing the e-mail campaign for distribution. When the user selects test e-mail button 172, a window 174 pops up to prompt the user to enter a name of someone to whom the test is sent. The tester name is entered in a “to:” line 176 of window 174 and then the user can press the “send test campaign” button 177.

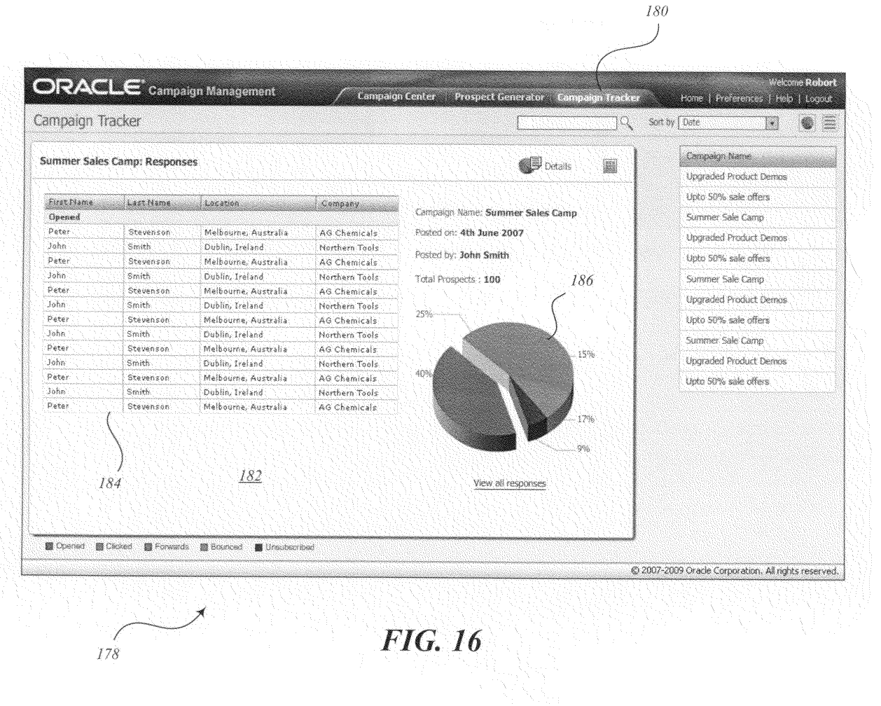

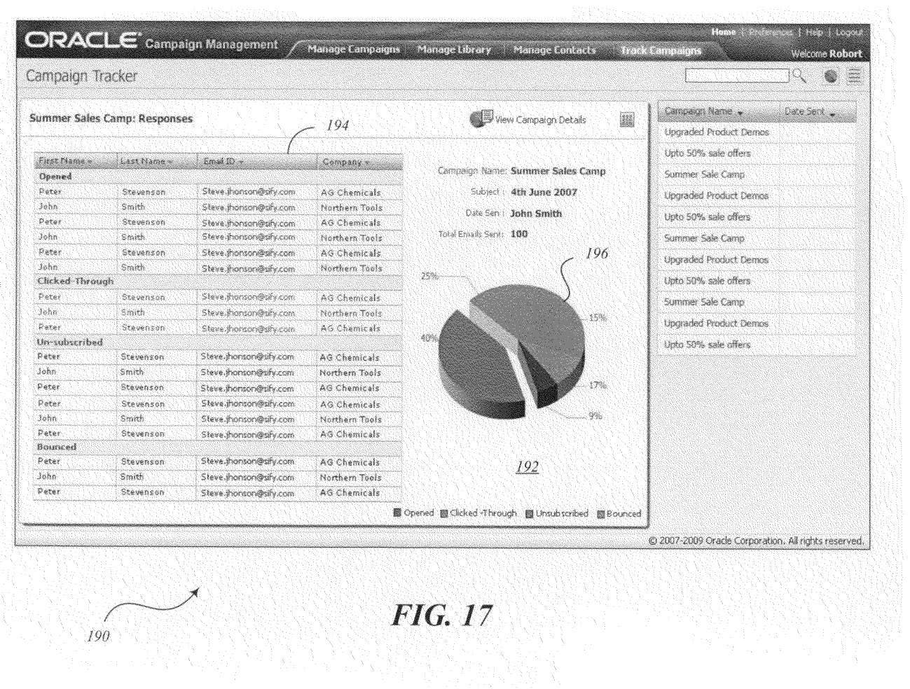

FIGS. 16-17 are diagrams showing a couple examples of a first UI 178 and a second UI 190, each for enabling a user to view information monitored with respect to an e-mail marketing campaign. These figures show the information that has been aggregated with respect to individual templates concerning the responses to the templates across multiple campaigns. The aggregated responses are tracked for each individual template rather than for the individual campaigns. However, in other embodiments, the responses can be tracked for each campaign as well, if this information is desired. In FIG. 16, UI 178 includes, among other things, a campaign tracker tab 180 for enabling the user to see results of the tracked statistics of an e-mail campaign. UI 178 also includes a tracker display area 182 showing a chart 184 of recipients and a pie chart 186 showing percentages of recipients.

In FIG. 17, UI 190 includes, among other things, a tracker display area 192 having a chart 194 of recipients and a pie chart 196 of percentages. In these examples, the statistics being displayed relates to the e-mail recipients and the percentages of recipients who have opened the e-mail, recipients who have clicked through links in the e-mail, recipients who have un-subscribed, e-mails to recipients that have bounced. In other embodiments, other statistics can be tracked and displayed.

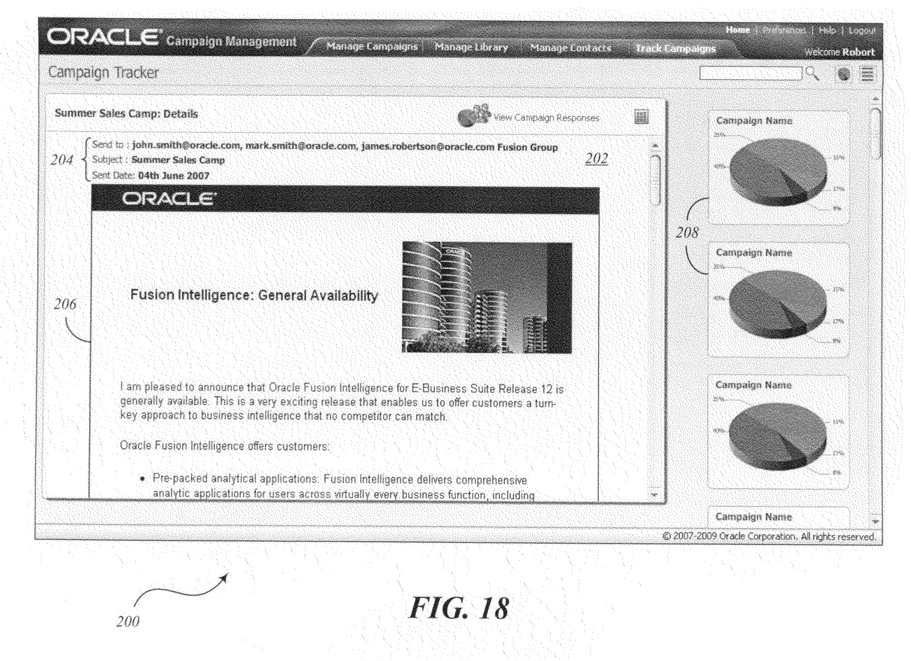

FIG. 18 is a diagram illustrating an example of a UI 200 for enabling a user to view the status of an e-mail marketing campaign. In this embodiment, UI 200 includes, among other things, an e-mail viewing area 202, which show envelope section 204 and a marketing template 206 that was incorporated in the e-mail or attached thereto. Envelope section 204 include the recipients to whom the e-mail of the e-mail campaign was sent, a subject line, and the date it was sent. Next to e-mail viewing area 202, UI 200 includes one or more campaign statistics charts 208, which show the campaigns in which template 206 has been attached. In this view, the user can see the effectiveness of the templates in each of the different campaign. It may be discovered that template 206, or any template being observed by the user, is more effective in certain campaigns, which may be divided up into multiple communities.

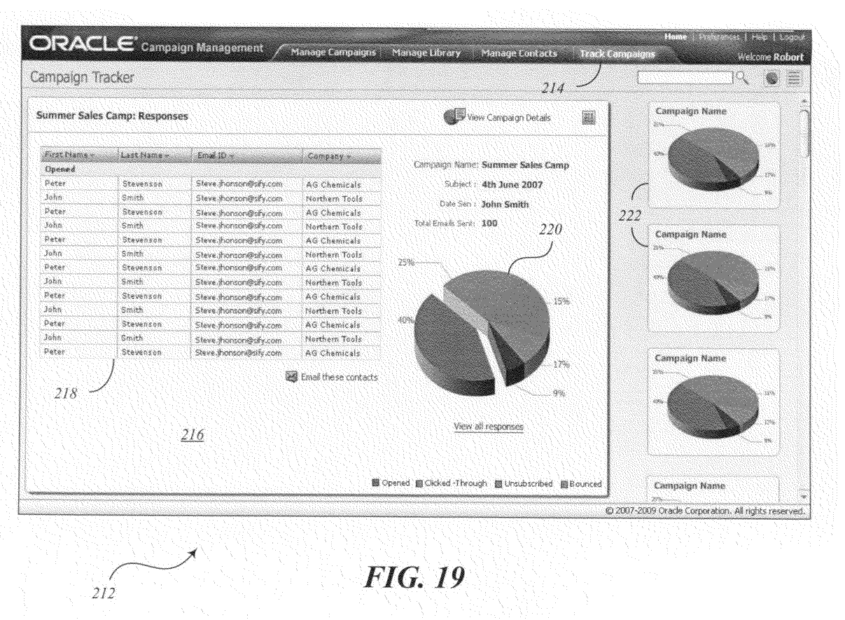

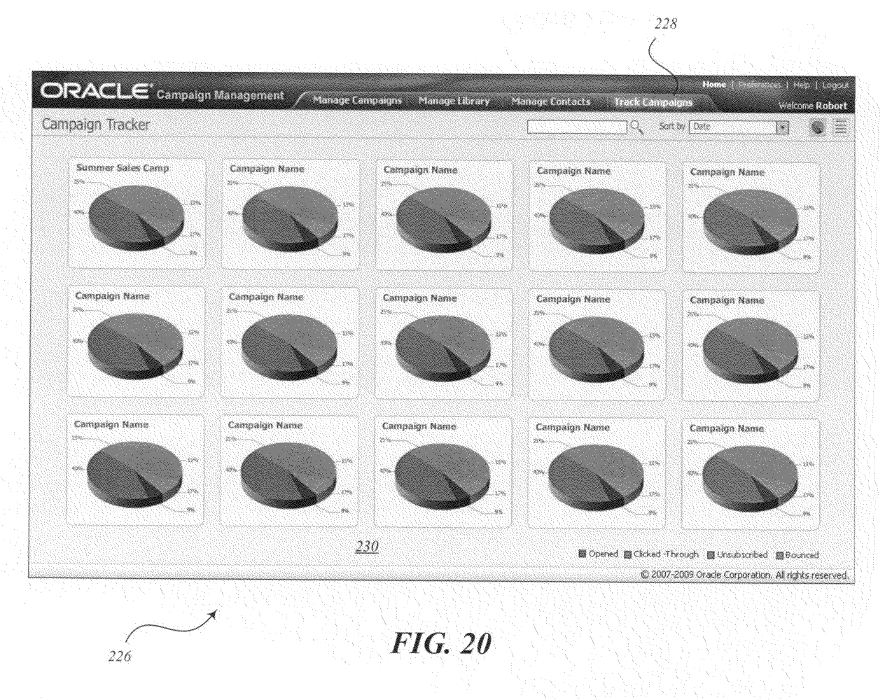

FIGS. 19-20 are diagrams showing examples of a first UI 212 and a second UI 226, each for enabling a user to view e-mail marketing campaigns being tracked. In this embodiment, UI 212 includes, among other things, a track campaign button 214 for enabling the user to view the statistics of a particular tracked campaign. The tracking of the campaigns can be associated with campaign tracking module 50 (FIG. 3). In this case, the tracked campaign is “Summer Sales Camp.” UI 212 also includes a tracked campaign statistics display area 216, which includes, for example, a recipient chart 218 and a pie chart 220 showing percentages of recipients who have opened, clicked through, un-subscribed, or bounced the e-mail. UI 212 also include one or more campaign statistics charts 222, which show the results of campaign statistics in which a particular template has been incorporated or attached. UI 226 of FIG. 20 includes track campaigns button 228 for enabling the user to view the campaign statistics. Also, UI 226 includes a campaign statistics viewing area 230, which shows the results of tracking the e-mail marketing campaigns in which the particular marketing template is incorporated.

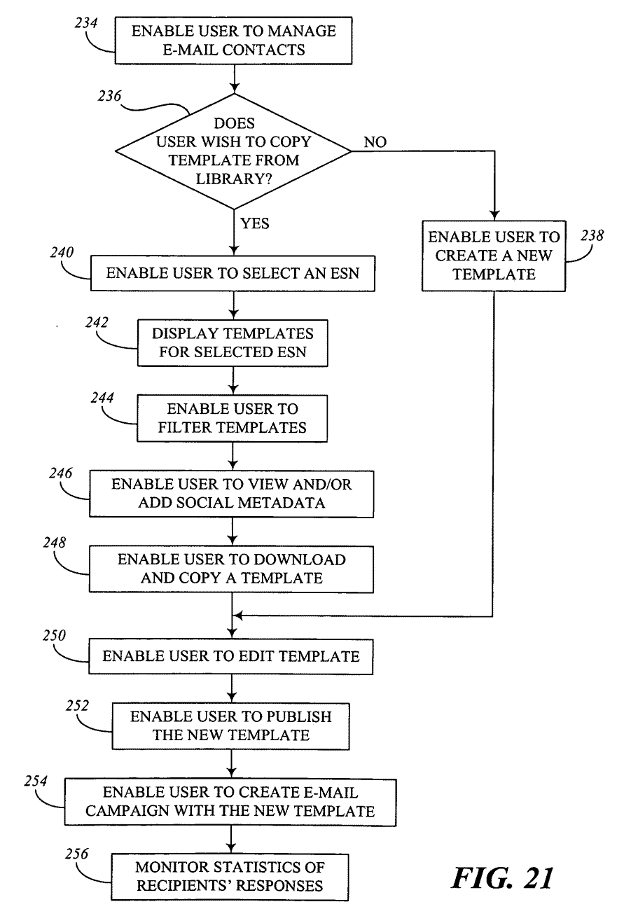

FIG. 21 is a flow diagram illustrating an embodiment of a method for managing an e-mail marketing campaign, according to one implementation. In this embodiment, the method includes enabling a user to manage e-mail contacts, as indicated in block 234. In some embodiments, the e-mail contacts can be managed in an ongoing manner or managed at any time during the e-mail marketing campaign before the marketing campaign is provided to the e-mail recipients.

As indicated in decision block 236, it is determined whether the user wishes to copy a marketing template from a library, such as a marketing template library. If the user does not wish to copy from the library, then the method goes to block 238, which enables the user to create a new template without the use of a previously prepared template. However, if the user does wish to copy from the library, then the flow proceeds to block 240. As indicated in block 240, the user is enabled to select a community, or enterprise social network (ESN). When an ESN is selected, templates for that selected ESN are displayed for the user's viewing, as indicated in block 242.

As indicated in block 244, the user is enabled to filter the templates using any suitable filtering techniques. This allows the user to narrow down the number of templates to make it easier to find a particular marketing template that the user may need. The user is also enabled to view and/or add social metadata for the individual templates, as indicated in block 246. According to block 248, the user is enabled to download and copy a selected marketing template. Once saved, the template can then be edited by the user.

When a new template is created according to block 238 or the user downloads a selected template, the method eventually rejoins at block 250, which indicates that the user is enabled to edit the template. As indicated in block 252, the user is enabled to publish the template. The template can be published on any public community or ESN of which the user is a member or can be published on a private community or ESN that the user creates or is invited to join. This published template or any other template available on the respective communities can then be used within an e-mail marketing campaign.

As indicated in block 254, the user is enabled to create an e-mail campaign with the new template or any other template that is accessible by the user. After the e-mails have been sent to the intended recipients, statistics of the responses of the recipients is monitored, as indicated in block 256. For example, some of the monitored statistics may include the number and/or percentage of e-mails that were opened, the number and/or percentage of links that were clicked within the e-mail, etc. More particularly, the statistics can be monitored with respect to each individual template, even those used across multiple marketing campaigns. The monitored statistics can be aggregated and stored for later use, such as in a UI that is capable of displaying the aggregated statistics.

It should be recognized that the method described with respect to FIG. 21 can be executed in several alternative ways. It should be understood that one or more of the steps, processes, and/or operations described herein may be executed substantially simultaneously or in a different order than explicitly described, as would be understood by one of ordinary skill in the art. For example, the user may wish to manage the e-mail contacts (block 234) at any time as needed. Also, blocks 240, 242, 244, 246, and 248 may be executed in any order and repeated as needed. Furthermore, the user may wish to skip many operations represented the blocks before block 254 if it is desired to create an e-mail campaign from a previously published template. In addition, some other operations can be executed again after the statistics are monitored (block 256), such as viewing the monitored responses, social metadata for the e-mail campaign, etc.

It should be understood that the steps, processes, or operations described herein may represent any module or code sequence that can be implemented in software or firmware. In this regard, these modules and code sequences can include commands or instructions for executing specific logical steps, processes, or operations within physical components. It should further be understood that one or more of the steps, processes, and/or operations described herein may be executed substantially simultaneously or in a different order than explicitly described, as would be understood by one of ordinary skill in the art.

The embodiments described herein represent a number of implementations and examples and are not intended to necessarily limit the present disclosure to any specific embodiments. Instead, various modifications can be made to these embodiments as would be understood by one of ordinary skill in the art. Any such modifications are intended to be included within the spirit and scope of the present disclosure and protected by the following claims.

We claim:

1. A computer readable medium configured to store instructions that are executable by a processing device, the computer readable medium comprising:
logic adapted to enable a user to create a marketing template;
logic adapted to enable the user to publish the marketing template on one or more social networks;
logic adapted to enable the user to incorporate the marketing template into an e-mail marketing campaign; and
logic adapted to track and aggregate statistics related to recipients' responses to the e-mail marketing campaign.

2. The computer readable medium of claim 1, further comprising logic adapted to enable the user to manage e-mail contacts.

3. The computer readable medium of claim 2, wherein the logic adapted to enable the user to manage e-mail contacts is further adapted to enable the user to import e-mail addresses from an external application.

4. The computer readable medium of claim 1, further comprising logic adapted to display templates shared within a particular social network.

5. The computer readable medium of claim 4, wherein the logic adapted to enable the user to filter the displayed templates.

6. The computer readable medium of claim 4, further comprising logic adapted to enable the user to download a copy of a template from the displayed templates.

7. The computer readable medium of claim 6, further comprising logic adapted to enable the user to edit the copied template.

8. The computer readable medium of claim 4, further comprising logic adapted to display social metadata, wherein social metadata relates to tags, comments, and ratings associated with a specific template.

9. The computer readable medium of claim 8, further comprising logic adapted to enable the user to add social metadata for the specific template.

10. The computer readable medium of claim 1, wherein the created template is an html template.

11. The computer readable medium of claim 10, wherein the html template comprises at least one of embedded links, embedded documents, and embedded images.

12. The computer readable medium of claim 1, further comprising logic adapted to enable the user to create a private social network.

13. The computer readable medium of claim 12, further comprising logic adapted to enable the user to establish collaboration rules for the private social network.

14. The computer readable medium of claim 12, further comprising logic adapted to enable the user to invite one or more other users to join the private social network.

15. The computer readable medium of claim 1, further comprising logic adapted to test the e-mail campaign.

16. A marketing campaign module comprising:
a template download module configured to enable a user to download a first marketing template from a marketing template library stored remotely;
a template upload module configured to enable the user to upload a second marketing template, the second marketing template being an edited version of the first marketing template or a newly created marketing template;
an e-mail campaign creating module configured to enable the user to create an e-mail marketing campaign that includes a third marketing template, the third marketing template being the first marketing template or second marketing template;
a template tracking module configured to automatically track statistics about the response of recipients of the e-mail campaign.

17. The marketing campaign module of claim 16, further comprising a template library managing module configured to enable a user to view a display of shared marketing templates stored in a marketing template library.

18. The marketing campaign module of claim 17, wherein the template library managing module further comprises a social metadata module, which comprises a tag processing module, a comment processing module, and a rating processing module, wherein the social metadata module is configured to enable the user to view and add social metadata to a specific marketing template.

19. The marketing campaign module of claim 17, wherein the template library managing module further comprises:
a search module configured to enable the user to conduct a text search for matching text in the marketing templates template library managing module; and
a template filtering module configured to enable the user to filter the text search.

20. The marketing campaign module of claim 16, further comprising an community creating module configured to enable the user to create a private community, the community creating module further configured to enable the user to invite one or more other users to join the private community.

21. A computer system comprising:
a memory device configured to store a campaign management module;
a processing device configured to execute logic of the campaign management module, the logic causing the processing device to:
enable a user to create a marketing template;
enable the user to create an e-mail marketing campaign having the marketing template incorporated therein;
aggregate responses from recipients of the e-mail marketing campaign to accumulate statistics regarding the e-mail marketing campaign and marketing template incorporated in the e-mail marketing campaign.

22. The computer system of claim 21, wherein the logic further causes the processing device to enable the user to publish the marketing template in association with one or more enterprise social networks (ESNs).

23. The computer system of claim 21, wherein the logic further causes the processing device to enable the user to download and store a copy of a shared marketing template from an enterprise social network with which the user is a member.
